(19) United States
(12) Patent Application Publication
(10) Pub. No.: US 2021/0382666 A1
(43) Pub. Date: Dec. 9, 2021

(54) GENERATING COLOR SPACE MAPPINGS

(71) Applicant: HEWLETT-PACKARD DEVELOPMENT COMPANY, L.P., Spring, TX (US)

(72) Inventors: Javier Maestro Garcia, Sant Cugat del Valles (ES); Jan Morovic, London (GB); Peter Morovic, Sant Cugat del Valles (ES)

(21) Appl. No.: 16/493,068

(22) PCT Filed: Apr. 6, 2018
(86) PCT No.: PCT/US2018/026550

§ 371 Date: Sep. 11, 2019

(51) Int. Cl. G06F 3/12; H04N 1/60; G01J 3/46

(52) U.S. Cl. CPC G06F 3/1208; G01J 3/46; H04N 1/603; G06F 3/1253

(57) ABSTRACT

Certain examples described herein relate to color spaces. In some cases, first and second sets of output color values representable in an output color space are obtained. The first and second sets of output color values correspond to first and second operating states of a printing system respectively. Each output color value in the first and second sets has corresponding coordinates in a colorimetry space. The first and second sets of output color values define respective first and second gamuts in the colorimetry space. First and second colorimetry values in an intersection of the first and second gamuts in the colorimetry space are selected, the selecting based on the respective colorimetry of the first and second colorimetry values and a predetermined transition region in an input color space. For an input color value located in the predetermined transition region of the input color space, a corresponding target colorimetry value located between the first and second colorimetry values in the colorimetry space is obtained. First and second output color values are derived based on the target colorimetry value and the first and second sets of output color values, respectively. First and second mappings between the input color space and the output color space are generated by respectively assigning the first and second output color values to the input color value.

### BACKGROUND

An imaging system may be associated with a color space, defined by colorants available to the imaging system for outputting an image. For example, a printing system may be associated with a color space, defined by colorants available to the printing system for deposition or application to a print medium. An example of a colorant color space is the Cyan, Magenta, Yellow, Black (CMYK) color space, wherein four variables are used in a subtractive color model to represent respective quantities of colorants. Examples of colorants include inks, dyes, pigments, paints, toners, light emitters, and powders.

### BRIEF DESCRIPTION OF THE DRAWINGS

Various features of the present disclosure will be apparent from the detailed description which follows, taken in conjunction with the accompanying drawings, which together illustrate, by way of example, features of the present disclosure, and wherein:

FIG. 1 is a schematic diagram of a printing system according to an example;

FIG. 2 is a schematic diagram showing a representation of a Neugebauer Primary area coverage vector according to an example;

FIG. 3 is a schematic diagram showing a representation of two different gamuts, and certain colorimetry values, within a colorimetry space according to an example;

FIG. 4 is a schematic diagram showing a mapping from an input color space to an output color space, via a lookup table, according to an example;

FIG. 5 is a flow chart illustrating a method according to an example; and

FIG. 6 is a schematic diagram of a processor and a computer readable storage medium with instructions stored thereon according to an example.

### DETAILED DESCRIPTION

Color can be represented within imaging devices such as print and display devices in a variety of ways. For example, in one case, a color as observed visually by an observer is defined with reference to a power or intensity spectrum of electromagnetic radiation across a range of visible wavelengths. In other cases, a color model is used to represent a color at a lower dimensionality. For example, certain color models make use of the fact that color may be seen as a subjective phenomenon, i.e. dependent on the make-up of the human eye and brain. In this case, a “color” may be defined as a category that is used to denote similar visual perceptions; two colors are said to be similar if they produce a similar effect on a group of one or more people. These categories can then be modelled using a lower number of variables.

Within this context, a color model may define a color space. A color space in this sense may be defined as a multi-dimensional space, with a point in the multi-dimensional space representing a color value and dimensions of the space representing variables within the color model. For example, in a Red, Green, Blue (RGB) color space, an additive color model defines three variables representing different quantities of red, green and blue light. In a digital model, values for these quantities may be defined with reference to a quantized set of values. For example, a color defined using an 8-bit RGB model may have three values stored in a memory, wherein each variable may be assigned a value between 0 and 255. Other color spaces include: a Cyan, Magenta, Yellow and Black (CMYK) color space, in which four variables are used in a subtractive color model to represent different quantities of colorant or printing fluid, e.g. for a printing system; the International Commission on Illumination (CIE) 1931 XYZ color space, in which three variables (X, Y and Z or tristimulus values) are used to model a color; the CIE 1976 (L*, a*, b*—CIELAB or ‘LAB’) color space, in which three variables represent lightness (L*) and opposing color dimensions (a* and b*); and the Yu′v′ color space, in which three variables represent the luminance (Y) and two chrominance dimensions (u′ and v′).

Other color spaces include area coverage spaces, such as the Neugebauer Primary area coverage (NPac) color space. An NPac vector in the NPac color space represents a statistical distribution of Neugebauer Primaries (NPs) over an area of a halftone. In a simple binary (bi-level, i.e. two drop states: “drop” or “no drop”) printer, an NP may be one of 2k-1 combinations of k printing fluids within the printing system, or an absence of printing fluid (resulting in 2k NPs in total). An NP may thus be seen as a possible output state for a print-resolution area. The set of NPs may depend on an operating configuration of a device, such as a set of available colorants. A colorant or printing fluid combination as described herein may be formed of one or multiple colorants or printing fluids. For example, if a bi-level printing device uses CMY printing fluids there can be eight NPs or output states. These NPs relate to the following: C, M, Y, CM, CY, MY, CMY, and W (white or blank indicating an absence of printing fluid). An NP may comprise an overprint of two available printing fluids, such as a drop of magenta on a drop of cyan (for a bi-level printer) in a common addressable print area (e.g. a printable “pixel”). An NP may be referred to as a “pixel state”.

In multi-level printers, e.g. where print heads are able to deposit N drop levels, an NP may include one of N^{k}−1 combinations of k printing fluids, or an absence of printing fluid (resulting in N^{k} NPs in total). A multi-level printer may use a piezo-electric or thermal print head that is capable of depositing different numbers of drops or different drop volumes, and/or may use multiple passes of a print head, to enact different drop states. For example, if a multi-level printer uses CMY printing fluids with four different drop states (“no drop”, “one drop”, “two drops” or “three drops”), available NPs can include C, CM, CMM, CMMM, etc. A “drop sequence” as used herein may define a set of drop states used or useable by a given printing system in a given operating state.

An NPac space provides a large number of metamers. Metamerism is the existence of a multitude of combinations of reflectance and emission properties that result in the same perceived color for a fixed illuminant and observer.

Each NPac vector may therefore define a probability distribution for colorant or printing fluid combinations for each pixel in the halftone (e.g. a likelihood that a particular colorant or printing fluid combination or available output state is to be placed or defined at each pixel location in the halftone). In this manner, a given NPac vector defines a set of halftone parameters that can be used in the halftoning process to map a color to NPs to be statistically distributed over the plurality of pixels for a halftone. Moreover, the statistical distribution of NPs to pixels in the halftone serves to control the colorimetry and other print characteristics of the halftone.

Spatial distribution of NPs according to the probability distribution specified in the NPac vector may be performed using a halftone method. Examples of suitable halftoning methods include matrix-selector-based Parallel Random Area Weighted Area Coverage Selection (PARAWACS) techniques and techniques based on error diffusion. This may result in discrete deposit instructions for print resolution pixels, e.g. instructing 0 to N drops of each of the k printing fluids on an addressable area of a print medium. Over a plurality of addressable areas, e.g. an area of print substrate, having a color defined by an NPac vector, the distribution of the printed output will tend towards the statistical distribution of area coverage defined by the NPac vector. An example of a printing pipeline that uses area coverage representations for halftone generation is a Halftone Area Neugebauer Separation (HANS) pipeline.

A color separation process may employ mappings between colors defined in a first color space and corresponding colors defined in a second color space. Such mappings may be stored in a data structure. For example, the mappings may be stored in a lookup table which may be accessed by the color separation process to map between the first and second color spaces. In some examples, a lookup table is used to map colorimetric values to vectors in an area coverage space. For example, the lookup table may map RGB or CMYK color values to NPac vectors. In some examples, the lookup table maps XYZ, LAB or any other color space used to specify a device color space. Where the vectors comprise NPac vectors, the lookup table may be referred to as a “HANS lookup table”. When an RGB mapping is used, the HANS lookup table may comprise 17³ entries. When a CMYK mapping is used, the HANS lookup table may comprise 9⁴ entries. The HANS lookup table may comprise a one-to-one mapping from input color values to NPac vectors.

An imaging system may operate to output colors, e.g. using an imaging device, in an output color space or “device color space”. Imaging systems may have multiple operating states, e.g. corresponding to different modes of the imaging system and/or imaging device. The different modes may lead to perceivable color differences in the output colors when produced by the imaging system. For example, the imaging system may use a color mapping to output a given output color value in the output color space when instructed, e.g. as part of an imaging operation, to produce a given color value specified in an input color space. When using the same color mapping in different operating states, or modes, the imaging system may output respective colors having perceivable differences. For example, the colors outputted in the respective operating states may have different hues (a phenomenon known as “hue shift”) or a difference in another perceivable color property.

For example, printing systems may utilize single-pass bidirectional print-modes, wherein a moveable printing device may pass over a print target in two directions. The different directions of the printing device may correspond to different operating states of the printing system. When using the same color mapping in the different operating states, the printing system may output respective colors having perceivable differences in hue or another color property. For example, printheads for depositing print materials of different colorants may be positioned on the moveable printing device. Thus, the order in which the colorants are deposited may be reversed when the printing device movement direction reverses, e.g. when bi-directionally scanning over the print target. Different colorants that are overprinted to produce output colors in the output color space may thus be overprinted in a different order, dependent on the direction of movement of the printing device. As a simple example, a halftone made up of one drop of cyan (C) and one drop of yellow (Y) may be printed as CY by the printing device moving in the first direction, e.g. cyan deposited first, followed by yellow. In the reverse direction, the printing device may print the halftone as YC, e.g. yellow deposited first, followed by cyan. The two halftones, CY and YC, may appear differently in the print output, e.g. they may be hue-shifted. The hue shifting between colors produced by the printing device moving in one direction versus the other direction may be noticeable, e.g. as “striping”, in the print output.

In some cases, different mappings between the input and output color spaces can be generated, the different mappings corresponding to the different operating states of the imaging system. Determination of the different mappings between corresponding color values in different color spaces may be a complex and time-consuming process. Determination of the mappings may involve printing and color-measuring output colors, e.g. NPac vectors, and then assigning certain NPac vectors to respective input color values (e.g. RGB values) in a color lookup table based on the measured colorimetries of the NPac vectors. Where the output color space is an NPac color space, the dimensionality is defined by the total number of NP states that are available for a given printing system in a given operating state, which in some cases may be in the order of 100,000 states or more. The total number of NP states is in turn dependent on the number of different colorants or printing fluids used by the printing system. The number of possible colorant combinations grows exponentially as additional colorants are introduced into the printing system. Some printing systems may use at least 9 colorants, with some colorants having multiple implementable drop-weight states.

The task may be further complicated by carrying out the determination process for each operating state, and selecting the different color maps which match colors when produced in the different operating states. Accordingly, due to the size and/or dimensionality of NPac space, manual pre-calculation of mappings for population of lookup tables to compensate for colorimetry differences produced by the imaging system in the different operation modes may be impractical.

Accordingly, certain examples described herein relate to generating different color mappings between input color values in an input color space and output color values in an output color space. The different color mappings may correspond to the different operating states of the imaging system, e.g. printing system. The different color mappings may be generated based on samplings of output color values producible in the respective operating states. In some cases, computational search and interpolation techniques can be utilized to derive the different output color values, corresponding to the different operating states, for desired color transitions in the input color space.

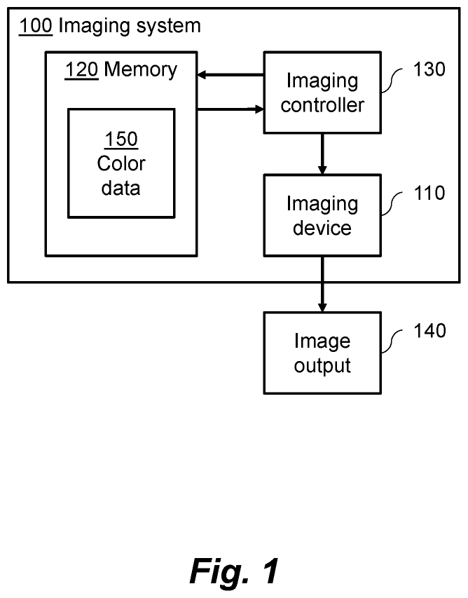

FIG. 1 shows an imaging system 100 according to an example. Certain examples described herein may be implemented within the context of this imaging system. As described above, in examples, the imaging system 100 may comprise a printing system, for example a 2D printing system such as an inkjet or digital offset printer, or a 3D printing system, otherwise known as an additive manufacturing system. In the example of FIG. 1, the imaging system 100 comprises an imaging device 110 (e.g. a printer or display device), a memory 120, and an imaging controller 130. The imaging controller 130 may be implemented using machine readable instructions that are executed by a processing device and/or suitably programmed or configured hardware. The imaging device 110 is arranged to produce an image output 140. For example, the imaging device 110 may include an electronic visual display such as a liquid crystal display (LCD) or a light emitting diode (LED) display or a 2D/3D printing system.

In examples where the imaging system 100 comprises a printing system, the imaging device 110 may comprise a printing device arranged to apply, e.g. print, a print material onto a print target in a printing process, for example to produce a print output as the image output 140. The print output may, for example, comprise colored printing fluids deposited on a substrate. The printing device may comprise an inkjet deposit mechanism, which may e.g. comprise a nozzle to deposit the print material. In 2D printing systems, the substrate may be paper, fabric, plastic or any other suitable print medium.

In 3D printing systems, the print output may be a 3D printed object. In such systems, the substrate may be a build material in the form of a powder bed comprising, for example, plastic, metallic, or ceramic particles. Chemical agents, referred to herein as “printing agents”, may be selectively deposited onto a layer of build material. In one case, the printing agents may comprise a fusing agent and a detailing agent. In this case, the fusing agent is selectively applied to a layer in areas where particles of the build material are to fuse together, and the detailing agent is selectively applied where the fusing action is to be reduced or amplified. In some examples, colorants may be deposited on a white (or “blank”) powder to color the powder. In other examples, objects may be constructed from layers of fused colored powder.

The memory 120 is to store data 150 representing first and second sets of output color values. Each output color value may be representable in an output color space. For example, each output color value may have, for each of a number N of axes defining an N-dimensional output color space, a respective coordinate value. In other words, the N-dimensional (N-D) color space may be defined by N axes, and an output color value may be representable within the N-D output color space by N coordinate values, each corresponding to one of the N axes, which indicate a location in the N-D color space of the output color value. A given axis may define and/or correspond to a given dimension of the output color space. A color value may thus indicate a position in a color space which corresponds to a color. A color value may also be referred to as a “color space node” or a “point in color space”.

The first and second sets of output color values correspond to first and second operating states of the imaging device 110, respectively. For example, the first and second sets of output color values may be producible by the imaging system 100, e.g. by the imaging device 110 when producing the image output 140, when the imaging device 110 is in the first and second operating states, respectively.

In examples, the imaging system 100 comprises a printing system. The imaging device 110 may comprise a printing device to apply print material onto a print target. The imaging controller 130 may comprise a print controller. In such examples, the printing device may be moveable in a first direction and a second direction to apply the print material onto the print target. For example, the printing device may be bidirectional to apply the print material onto the print target in a single pass over the print target. The first and second operating states of the imaging device may thus comprise, e.g. correspond to, the printing device moving in the first and second directions, respectively.

In examples, the printing device comprises a moveable carriage having an inkjet deposit mechanism located thereon. The inkjet deposit mechanism may, for example, comprise a nozzle to deposit the print material, as described. In certain cases, the inkjet deposit mechanism includes a plurality of nozzles, each of the nozzles to deposit print material of a corresponding colorant. The plurality of nozzles may be arranged on the carriage, as part of the inkjet deposit mechanism, in a given order. Thus, when the carriage moves in the first direction, corresponding to the first operating state of the printing device, the different colorants may be deposited in a first order. Conversely, when the carriage moves in the second direction, corresponding to the second operating state of the printing device, the different colorants may be deposited in a second order.

In examples, the first and second sets of output color values respectively comprise first and second sets of Neugebauer Primary Area Coverage (NPac) vectors. Each NPac vector may define a statistical distribution of Neugebauer Primaries (NPs) over an area of a halftone, as described above.

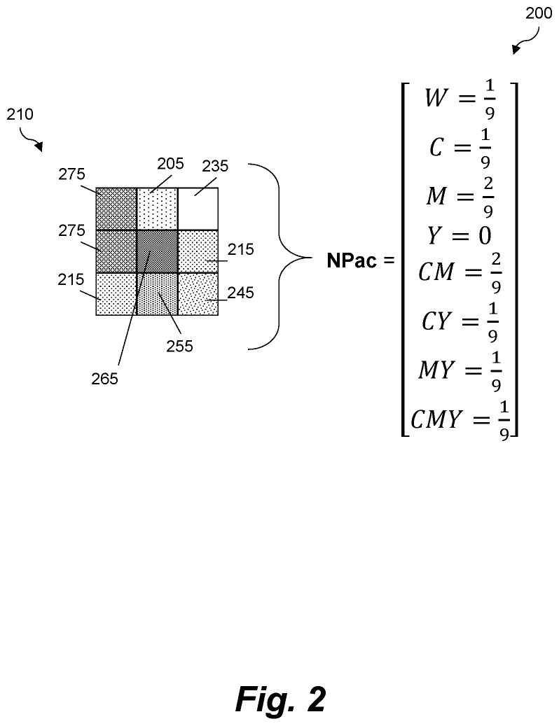

FIG. 2 shows an example NPac vector 200 for use in a CMY imaging system. The NPac vector 200 may correspond to an output color value in accordance with examples described herein. This example shows a three-by-three pixel area 210 of a print output where all pixels have the same NPac vector 200. The NPac vector 200 defines the probability distributions for each NP for each pixel, for example a likelihood that NPₓ is to be placed at the pixel location. Hence, in the example print output there is one pixel of White (W) (235); one pixel of Cyan (C) (245); two pixels of Magenta (M) (215); no pixels of Yellow (Y); two pixels of Cyan+Magenta (CM) (275); one pixel of Cyan+Yellow (CY) (255); one pixel of Magenta+Yellow (MY) (205); and one pixel of Cyan+Magenta+Yellow (CMY) (265). Generally, the print output of a given area is generated such that the probability distributions set by the NPac vectors of each pixel are fulfilled. For example, the NPac vector may be effected by a halftone stage that implements the spatial distribution of colorant combinations defined by the vector, e.g. via a series of geometric shapes such as dots of predetermined sizes being arranged at predetermined angles. As such, an NPac vector is representative of the colorant overprint statistics of a given area. Although a CMY system is used for ease of explanation, other imaging systems may be used.

In other examples, the first and/or second set of output color values comprises a set of RGB, CMYK, CcMmYK, XYZ, CIELAB, CIELUV or YUV color values. In some examples, the first and/or second set of output color values comprises a set of area coverage vectors. An area coverage vector may comprise a set of components that are to be distributed over an area of a halftone. As such, the first and/or second set of output color values may comprise a set of halftone parameters. An example of an area coverage vector is an NPac vector, described above. In some examples, the first and/or second set of output color values comprises a set of colorant-use vectors. A colorant-use vector may be an area coverage vector. A colorant-use vector comprises components corresponding to individual colorants implementable by the printing system. For example, the colorant-use vector components may correspond respectively to cyan (C), magenta (M), yellow (Y) and black (K) colorants for a printing system associated with the CMYK color space. Values of the components may correspond respectively to the amount of the corresponding colorant used relative to the other colorants represented in the colorant-use vector.

Each output color value in the first and second sets has a corresponding measured colorimetry value representable in a colorimetry space. The colorimetry space may comprise a color space describing perceivable colors, for example the CIELAB or CIEXYZ color space. The colorimetry color space may be considered a “reference color space”. The measured colorimetry values, corresponding to the output color values in the first and second sets, may comprise reference color values in the reference color space. The measured colorimetry values may be derivable by measurement of a colorimetry of each output color value in the first and second sets of output color values.

The data 150 representing the first and second sets of output color values, stored by the memory 120, may thus comprise data representing the measured colorimetry values corresponding to the output color values in the first and second sets.

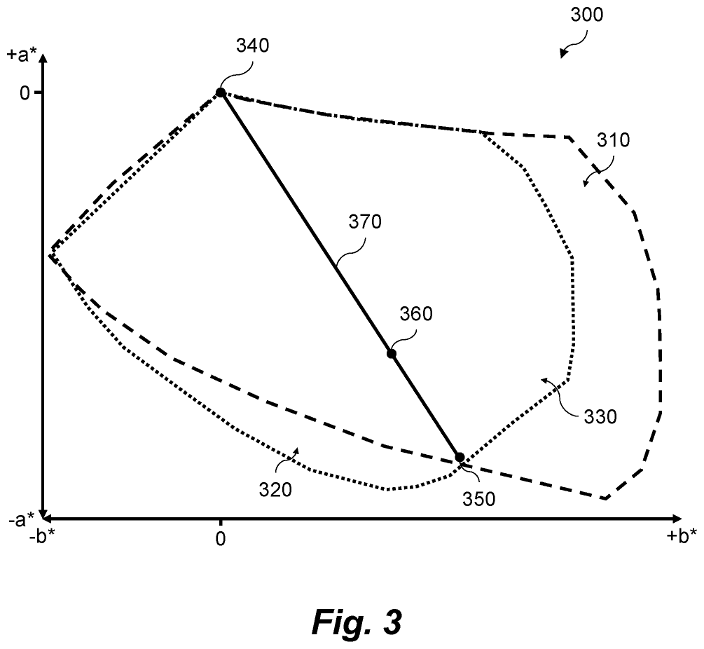

FIG. 3 shows an example colorimetry space 300. In this example, a chromaticity plane of the colorimetry space 300 is shown. The chromaticity plane comprises a 2D plane of the colorimetry space, e.g. defined by two independent parameters of the colorimetry space (which may have a greater dimensionality than 2D). For example, the colorimetry space 300 of FIG. 3 is a CIELAB color space, a 3D space defined by three parameters: lightness (L*) and two color channels (a* and b*). FIG. 3 shows an a*-b* chromaticity plane of the CIELAB color space 300. Colorimetry values representable in the 3D CIELAB color space may be projected onto the a*-b* plane.

The first set of output color values defines a first gamut 310 in the colorimetry space 300. For example, the measured colorimetry values corresponding to the output color values in the first set of output color values may define the first gamut 310 in the colorimetry space 300. The first gamut 310 may comprise a convex hull, or convex envelope, of the measured colorimetry values corresponding to the first set of output color values. For example, each measured colorimetry value may correspond to a point in the CIELAB color space 300 having (a*, b*) coordinates, wherein the respective a*, b* coordinate values are derived from colorimetry measurements. The measured colorimetry values may thus be represented as a distribution of (a*, b*) coordinates in the CIELAB color space 300. The distribution of (a*, b*) coordinate points may define a gamut, e.g. a convex hull, enclosing the distribution in the a*-b* plane. FIG. 3 shows the first gamut 310 represented by a region in the a*-b* plane bounded by a dashed line.

Similarly, the second set of output color values defines a second gamut 320 in the colorimetry space 300. FIG. 3 shows the second gamut 320 represented by a region in the a*-b* plane bounded by a dotted line. In examples, the first and second gamuts 310, 320 are three-dimensional, e.g. enclosing respective distributions of points defined by three coordinates in a 3D colorimetry space. For example, the a*-b* plane shown in FIG. 3 may be extended in a third dimension defined by the lightness (L*) parameter of the CIELAB color space 300. The respective distributions of measured colorimetry values may thus be 3D distributions of (L*, a*, b*) coordinates in the CIELAB color space 300. The respective first and second gamuts 310, 320, e.g. convex hulls, enclosing the distributions may correspondingly be 3D.

The first and second gamuts 310, 320 in the colorimetry space 300 may be respective subsets of the colorimetry space 300. For example, the first gamut 310 may be a complete subset of colorimetry values within the entire colorimetry space 300. The first gamut 310 may thus describe a subset of colorimetry values, within the colorimetry space 300, that are producible by the imaging device 110 when in the first operating state. Similarly, the second gamut 320 may describe another subset of colorimetry values, within the colorimetry space 300, that are producible by the imaging device 110 when in the second operating state.

The imaging controller 130 (e.g. print controller) is to select first and second colorimetry values 340, 350 in an intersection 330 of the first and second gamuts 310, 320 in the colorimetry space 320. The intersection 330 of the first and second gamuts 310, 320 may be a region of overlap between the first and second gamuts 310, 320 in the colorimetry space 320. For example, the intersection 330 of the first and second gamuts 310, 320 may contain all colorimetry values of the first gamut 310 that also belong to the second gamut 320, but no other colorimetry values. The intersection 330 of the first and second gamuts 310, 320 may describe a further subset of colorimetry values, within the colorimetry space 300, that are producible by the imaging device 110 when in either of the first or second operating state.

The selecting by the imaging controller 130 is based on the respective colorimetry of the first and second colorimetry values and a predetermined transition region in an input color space.

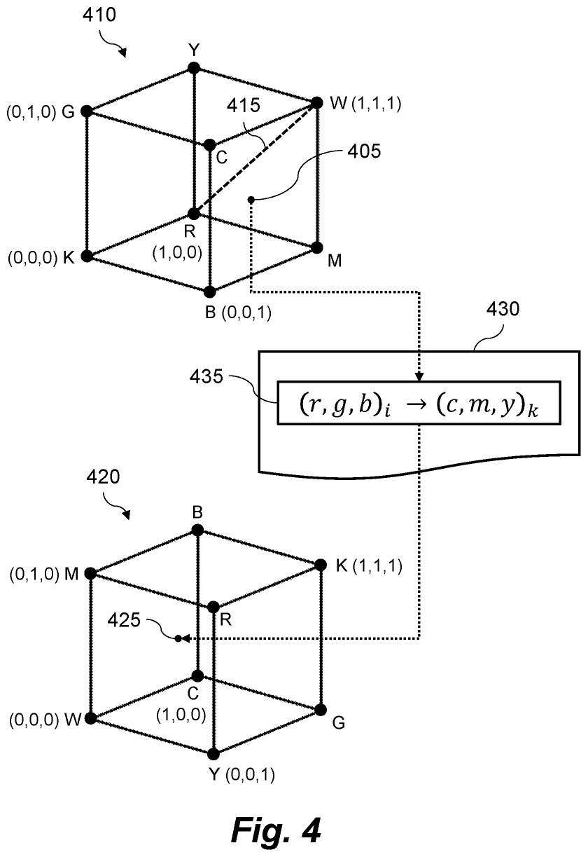

FIG. 4 is schematic diagram showing a first color space 410, e.g. an input color space. In this example, the input color space 410 is an RGB color space represented as a cube in a three-dimensional space. In other examples, the image color space may be a CMYK color space, e.g. represented as a hypercube in four-dimensional space.

A vertex of a color space may be a location in the color space where all component coordinates are either at a minimum or maximum in the color space (e.g. at either 0 or 1 when normalized). For example, the vertices of the RGB color space 410 shown in FIG. 4, in normalized (r, g, b) coordinates, are: black (K) at (0, 0, 0); white (W) at (1, 1, 1); red (R) at (1, 0, 0); green (G) at (0, 1, 0); blue (B) at (0, 0, 1); yellow (Y) at (1, 1, 0); magenta (M) at (1, 0, 1); and cyan (C) at (0, 1, 1). In examples where the first color space is a color space having N dimensions, the number of vertices in the first color space may be 2″. For example, the CMYK color space, having four dimensions, may be represented as a 4D hypercube with 2⁴=16 vertices.

The white point of a color space may comprise a set of coordinates in the color space, e.g. a set of tristimulus values, that corresponds to, or defines, the color white (W) in the color space. Similarly, the black point of a color space may comprise a set of coordinates in the color space, e.g. a set of tristimulus values, that corresponds to, or defines, the color black (K) in the color space. For example, in the RGB color space 410 shown in FIG. 4, the black point is located at normalized (r, g, b) tristimulus values (0, 0, 0) and the white point is located at normalized (r, g, b) tristimulus values (1, 1, 1). In the CMY color space 420 shown in FIG. 4, the white point is located at normalized (c, m, y) tristimulus values (0, 0, 0) and the black point is located at normalized (c, m, y) tristimulus values (1, 1, 1).

A color transition 415 in the input color space 410 may comprise a particular vertex-to-vertex axis of the input color space 410. For example, a vertex-to-vertex axis of a color space may comprise a vertex-to-vertex edge of the color space, e.g. a line between vertices of the color space that defines a boundary of the color space. In examples, a vertex-to-vertex axis of a color space may comprise a vertex-to-vertex diagonal on a surface of the color space, such as the RW transition 415 between the white point (W) and the red vertex (R) of the input (RGB) color space 410. Such diagonals of the input color space 410, on respective surfaces of the input color space 410, may be termed “surface ramps” of the input color space 410. The surface ramps of the input color space 410 may comprise color-to-white ramps between a color vertex of the first color space and the white point of the color space, e.g. the RW diagonal 415. The surface ramps of the input color space 410 may also comprise color-to-black ramps between a color vertex and the black point of the input color space 410, e.g. the MK, CK, and YK ramps of the RGB color space 410. In certain cases, the start and end points of the transition 415 may be defined as vertices, or other points, in a color space.

The predetermined transition region may comprise a transition between two points in the input color space, e.g. a color transition or ramp, as described. For example, the predetermined transition region may comprise a given region of the input color space 410, the given region containing the transition between two points in the input color space. A given transition may comprise a plurality of transition points along the transition. A color transition in the input color space 410 may therefore be defined, additionally or alternatively, by a trajectory along successive transition points in the input color space 410.

As described above, the selecting of the first and second colorimetry values 340, 350, by the imaging controller 130, is based on the respective colorimetry of the first and second colorimetry values 340, 350 and the predetermined transition region in the input color space 410.

For example, the selecting of the first and second colorimetry values based on their respective colorimetry may include selecting the first and second colorimetry values based on a linear or angular separation therebetween in the chromaticity plane of the colorimetry space 300. For example, the first and second colorimetry values 340, 350 may be selected to have a linear or angular separation, in the intersection 330 of the first and second gamuts 310, 320 in the colorimetry space, larger than a predetermined threshold. In examples. In certain cases, the first and second colorimetry may be selected to have a maximum linear or angular separation in the intersection of the first and second gamuts in the colorimetry space.

A linear separation between two colorimetry values in the colorimetry space may correspond with a relative linear distance in the colorimetry space, e.g. in the N-dimensions of the color space or projected to a lower dimensionality. For example, the linear separation between the first and second colorimetry values 340, 350 in the CIELAB colorimetry space 300 may correspond to a linear separation along the trajectory 370 in the a*-b* chromaticity plane, as shown in FIG. 3. The linear separation between the points in the 2D a*-b* chromaticity plane may be a projection of the corresponding linear separation in the 3D L*a*b* volume. In examples, the linear separation between the first and second colorimetry values may comprise a radial separation therebetween in the colorimetry space, e.g. in a chromaticity plane thereof. The radial separation between two points in a given colorimetry space may correspond to a linear separation along a radius of the colorimetry space, e.g. the radius extending from an origin or reference point or axis of the colorimetry space. The origin or reference point may be the white-point or black-point of the colorimetry space. The origin or reference axis may be an axis extending through the white- and/or black-point of the colorimetry space, e.g. the neutral axis or “gray scale” thereof.

Similarly, an angular separation between two colorimetry values in the colorimetry space may correspond with a relative angular separation in the colorimetry space. The angular separation between two points in a colorimetry space may correspond to an angular separation between two tangents passing through the respective points from a reference point in the colorimetry space, e.g. the white-point. Analogously to linear separations described above, an angular separation in an N-dimensional colorimetry space may be projected to a subspace of lower dimensionality. For example, an angular separation between two colorimetry values in the 3D L*a*b* volume may be projected to a corresponding angular separation between the two colorimetry values in the 2D a*-b* chromaticity plane.

As an example, for generating mappings from a white-to-color transition in the input color space, the first colorimetry value may be selected based on the colorimetry of the first colorimetry value corresponding to a white-point, or neutral point, in the colorimetry space. The second colorimetry value may be selected within the intersection between the first and second gamuts based on a separation, e.g. a linear separation, from the first colorimetry value in the colorimetry space, e.g. in the chromaticity plane. Additionally or alternatively, the second colorimetry value may be selected based on the colorimetry thereof corresponding to the color of the white-to-color transition in the input color space.

Another example involves generating mappings from a color-to-color transition, e.g. an edge or surface ramp, in the input color space. The first colorimetry value may be selected based on the colorimetry of the first colorimetry value in the colorimetry space corresponding to one of the colors of the color-to-color transition in the input color space. The second colorimetry value may be selected within the intersection between the first and second gamuts based on a separation, e.g. an angular separation, from the first colorimetry value in the colorimetry space, e.g. in the chromaticity plane. Additionally or alternatively, the second colorimetry value may be selected based on the colorimetry thereof corresponding to the other color of the color-to-color transition in the input color space.

For a given input color value located in the predetermined transition region of the input color space 410, the imaging controller 130 is to obtain a corresponding target colorimetry value 360, located between the first and second colorimetry values 340, 350, in the colorimetry space 300.

For example, the imaging controller 130 may obtain the corresponding target colorimetry value 360 such that the target colorimetry value 360 is representable in the colorimetry space 300 as located on a trajectory 370 between the first and second colorimetry values 340, 350 in the colorimetry space 300. The trajectory 370 may be an axis or other path between the first and second colorimetry values 340, 350, for example.

In examples, the imaging controller 130 is to define the trajectory 370, e.g. the axis or other path, between the first and second colorimetry values 340, 350 in the colorimetry space 300. The imaging controller 130 may obtain the corresponding target colorimetry value 360 located on the defined trajectory 370. In some examples, obtaining the corresponding target colorimetry value 360 comprises selecting the corresponding target colorimetry value 360. In certain cases, a given number of color values in the predetermined transition region of the input color space 410 may be selected for respectively associating with the same number of color values in the output color space 420. For example, the given number of color values in the input color space 410 may be selected for storing as part of respective nodes 435 in a color lookup table 430, as described further below with reference to FIG. 4. The same given number of target colorimetry values 360 may be selected in the colorimetry space 300. For example, if a particular transition in the input color space, e.g. a white-to-color transition 415, is to be sampled with eight color values to form eight nodes 435 of a color lookup table 430, eight target colorimetry values 360 may be obtained, e.g. selected, in the colorimetry space 300. The eight target colorimetry values 360 may comprise the selected first and second colorimetry values 340, 350, e.g. such that six intermediate target colorimetry values 360 are selected.

The imaging controller 130 is to derive first and second output color values based on the target colorimetry value 360 and the first and second sets of output color values, respectively. For example, the first output color may be derived by the imaging controller 130 interpolating between a plurality of, e.g. at least two, color values in the first set of color values. The at least two color values in the first set of color values may obtained, e.g. selected, based on the target colorimetry value 360 and the measured colorimetry values corresponding to the at least two color values in the first set of color values. Similarly, in examples, the imaging controller 130 is to derive the second output color value by interpolating between a plurality of color values in the second set of color values, e.g. a subset of the second set of color values. The subset of color values in the second set of color values may be obtained, e.g. selected, based on the target colorimetry value 360 and the measured colorimetry values corresponding to the respective color values in the subset.

In some examples, the imaging controller 130 is to derive the first and second output color values by triangulating between the obtained subsets of the first and second sets of color values, respectively. Triangulation may comprise calculating a weighted average among multiple color values in the first or second subset of color values. Such a weighted average may be calculated using a barycentric coordinate system or a trilinear coordinate system, for example. As such, the derived first and/or second output color values may include a color value that is not in the first and/or second sets of color values.

In examples, the imaging controller 130 is to generate first and second output data respectively associating the first and second output color values in the output color space with the input color value in the input color space.

Returning to FIG. 4, an example output color space 420 is shown. In this example, the output color space 420 is a CMY color space represented as a cube in three-dimensional space. In other examples, the target color space may be a CMYK color space, e.g. represented as a hypercube in four-dimensional space. Further examples of target color spaces include three-dimensional CIELAB and CIELUV color spaces. Other examples include N-dimensional NPac and colorant-use vector (e.g. ink-vector) color spaces, defined by a number N of NPs and colorants (e.g. inks) respectively.

The vertices of the CMY color space 420 shown in FIG. 4, in normalized (c, m, y) coordinates, are: white (W) at (0, 0, 0); black (K) at (1, 1, 1); cyan (C) at (1, 0, 0); magenta (M) at (0, 1, 0); yellow (Y) at (0, 0, 1); blue (B) at (1, 1, 0); green (G) at (1, 0, 1); and red (R) at (0, 1, 1).

Example output data 435 associates an input color value, e.g. (r, g, b)ᵢ, in the input (RGB) color space 410 to an output color value 425, e.g. (c, m, y)ₖ, in the output color space 420. For example, the output data 435 is to map from input color values in the input color space 410 to output color values in the output color space 420.

In examples, the imaging controller 130 is to store the generated first and second output data, respectively associating the first and second output color values with the input color value, in respective first and second color lookup tables.

FIG. 4 shows an example color lookup table 430, which may e.g. comprise a data structure. The color lookup table 430 comprises the example output data 435 mapping from an input color value to an output color value. The example output data 435 may comprise a node of the color lookup table 430. Each node 435 of the color lookup table 430 may correspond to a mapping from a given input color value 405 in the first color space 410 to a given output color value 425 in the second color space 420.

In examples, the imaging controller 130 is to receive image control data for an imaging operation. The imaging operation may be for producing the image output 140 at the imaging device 110. In certain cases, the image control data comprises the input color value in the input color space, for which the first and second output color values were assigned to generate the first and second mappings.

The imaging controller 130 may determine the operating state of the imaging system 100. In response to determining that the imaging system 100 is in the first operating state, the imaging controller 130 may use the first color lookup table to perform the imaging operation. Alternatively, in response to determining that the imaging system 100 is in the second operating state, the imaging controller 130 may use the second color lookup table to perform the imaging operation.

For example, as described, in some cases the imaging system 100 comprises a printing system having a moveable printing device to deposit printing material. The moveable printing device may be moveable in two directions, e.g. to scan over a print target, to selectively deposit print material onto the print target.

The first operating state of the printing system may correspond with the printing device moving in the first direction, e.g. such that different printing material colorants are deposited in a first order. The second operating state of the printing system may correspond with the printing device moving in the second direction, e.g. such that the different printing material colorants are deposited in a second order.

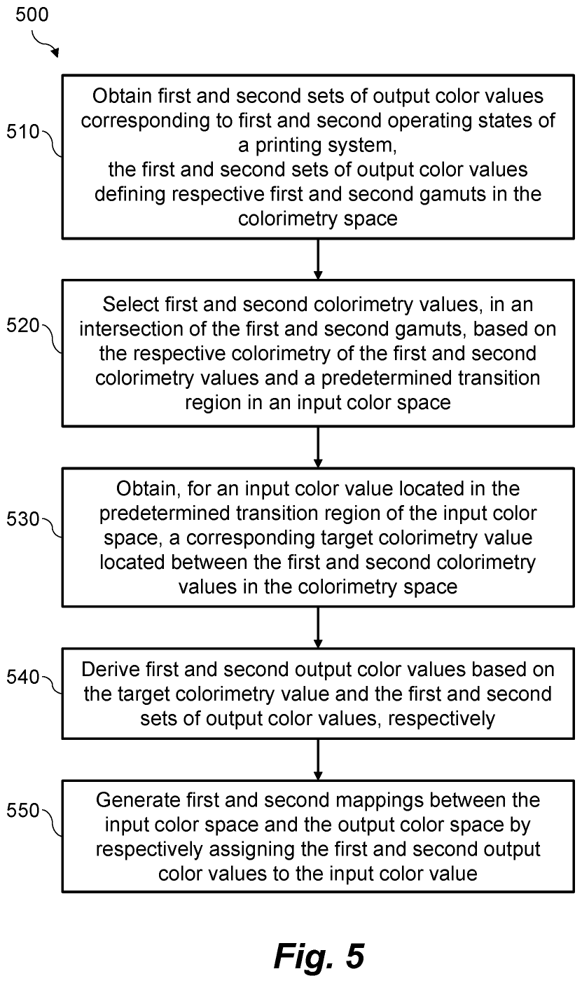

FIG. 5 shows a method 500 according to an example. In some examples, the method 500 is performed by an imaging controller such as the imaging controller 130 described with reference to FIG. 1. The imaging controller 130 may perform the method 500 based on instructions retrieved from a computer-readable storage medium. In examples, the imaging system comprises a printing system. In such cases, the imaging controller may comprise a print controller.

At block 510, first and second sets of output color values representable in an output color space are obtained. The first and second sets of output color values correspond to first and second operating states of the printing system respectively.

In examples, the first and second sets of output color values respectively comprise first and second sets of Neugebauer Primary Area Coverage (NPac) vectors, as previously described. In other examples, the first and second sets of output color values comprise color values representable in a color space different to the NPac color space, e.g. the RGB, CMYK, CcMmYK, XYZ, CIELAB, CIELUV or YUV color space. In examples, the first and/or second set of output color values comprises a set of area coverage vectors or colorant-use vectors.

In some examples, the method 500 involves determining the first and second sets of output color values corresponding to the first and second operating states of a printing system respectively. For example the first and second sets of output color values may be determined based on the output color values that are producible by the printing system when operating in the first and second operating states respectively. In certain cases, either or both of the first and second sets of output color values may be determined as a subset of all the output color values producible by the printing system when in the respective operating state. For example, the determining may be based on a criterion relating to the printing process, e.g. an overprinting criterion. In such examples, the number of output color values, in the first and/or second sets, that are producible by the printing system overprinting different colorants is limited, e.g. reduced.

In examples, the printing system comprises a print material deposit mechanism to selectively deliver print material. The print material deposit mechanism may be a printhead, such as a thermal printhead or a piezo inkjet printhead where the ejection mechanism is based on thermal or piezoelectric elements, respectively. In some examples, the printhead may be a drop-on-demand printhead. In other examples, the printhead may be continuous-drop printhead. The printhead may include one or more nozzles, e.g. an array of nozzles, configured to deposit the printing material(s) onto a print target, e.g. substrate. In one example, printheads such as those used in commercially available inkjet printers may be used. In other examples, the printing material(s) may be delivered through spray nozzles rather than through printheads. Other delivery mechanisms may be used as well.

The print material deposit mechanism may be used to selectively deliver, e.g. deposit, print material(s) when in the form of a suitable fluid, such as liquid. In some examples, the print material deposit mechanism may have an array of nozzles through which the print material deposit mechanism is able to selectively eject drops of fluid. In some examples, each drop may be in the order of about 10 picoliters (pl) per drop, although in other examples the print material deposit mechanism is able to deliver a higher or lower drop size. In some examples the print material deposit mechanism is able to deliver variable size drops.

The print material deposit mechanism may be moveable to selectively deposit the print material(s). For example, the print material deposit mechanism may scan in two directions over the print target when selectively applying print material(s) thereto. The first operating state of the printing system may thus correspond to a first direction of movement of the print material deposit mechanism. The second operating state of the printing system may correspond to a second direction of movement of the print material deposit mechanism.

Each output color value in the first and second sets has corresponding coordinates in a colorimetry space. For example, the coordinates in the colorimetry space, corresponding to each output color value in the first and second sets of output color values, may comprise measured colorimetry values. Each output color value in the first and second sets may therefore be associated with a measured colorimetry value representable in the colorimetry space. As described, the colorimetry space may comprise a color space describing perceivable colors, for example the CIELAB or CIEXYZ color space.

In examples, the method 500 includes printing swatches, e.g. patches, using the printing system. The swatches may correspond to the output color values in the first and second sets of output color values. A colorimetry of each of the swatches may be measured, e.g. using a measurement device. Examples of such a measurement device include, but are not limited to, photodiodes, spectrophotometers, spectrofluorometers, spectrocolorimeters, tristimulus colorimeters, densitometers and lightness sensors. The measurement device may be part of, or separate from, the printing system. The measured colorimetries may be useable to derive the measured colorimetry values, e.g. to derive coordinate values in the colorimetry space, corresponding to each of the output color values in the first and second sets of output color values.

The first and second sets of output color values define respective first and second gamuts in the colorimetry space. As described, the first and second gamuts may each comprise a convex hull, or convex envelope, of the measured colorimetry values corresponding to the first and second sets of output color values, respectively.

In examples, the respective first and second gamuts in the colorimetry space, corresponding to the first and second sets of output color values, are represented in a chromaticity plane of the colorimetry space. The chromaticity plane may comprise a 2D plane of the colorimetry space, e.g. defined by two independent parameters of the colorimetry space. The two independent parameters of the colorimetry space may comprise color components, e.g. color channels, of the colorimetry space. Examples include the a* and b* components of the CIELAB color space, the u* and v* components of CIELUV color space, and the X and Z components of the CIEXYZ color space.

At block 520, first and second colorimetry values, in an intersection of the first and second gamuts in the colorimetry space, are selected. The selecting is based on the respective colorimetry of the first and second colorimetry values and a predetermined transition region in an input color space, as described above with reference to FIG. 3.

In examples, the selecting of the first and second colorimetry values based on their respective colorimetry includes selecting the first and second colorimetry values based on a linear or angular separation therebetween in the chromaticity plane of the colorimetry space. For example, the first and second colorimetry may be selected to have a linear or angular separation, in the intersection of the first and second gamuts in the colorimetry space, larger than a predetermined threshold. In certain cases, the first and second colorimetry values may be selected to have a maximum linear or angular separation in the intersection of the first and second gamuts in the colorimetry space.

As an example, for generating mappings from a white-to-color transition in the input color space, the first colorimetry value may be selected based on the colorimetry of the first colorimetry value corresponding to a white-point, or neutral point, in the colorimetry space. The second colorimetry value may be selected within the intersection between the first and second gamuts based on a separation, e.g. a linear separation, from the first colorimetry value in the colorimetry space, e.g. in the chromaticity plane. Additionally or alternatively, the second colorimetry value may be selected based on the colorimetry thereof corresponding to the color of the white-to-color transition in the input color space, e.g. green (G) for a WG transition in the input color space.

Another example involves generating mappings from a color-to-color transition, e.g. an edge or surface ramp, in the input color space. The first colorimetry value may be selected based on the colorimetry of the first colorimetry value in the colorimetry space corresponding to one of the colors of the color-to-color transition in the input color space. The second colorimetry value may be selected within the intersection between the first and second gamuts based on a separation, e.g. an angular separation, from the first colorimetry value in the colorimetry space, e.g. in the chromaticity plane. Additionally or alternatively, the second colorimetry value may be selected based on the colorimetry thereof corresponding to the other color of the color-to-color transition in the input color space.

At block 530, a target colorimetry value corresponding to an input color value located in the predetermined transition region of the input color space is obtained. The target colorimetry value is located between the first and second colorimetry values in the colorimetry space. For example, the target colorimetry value may be obtained based on the target colorimetry value being representable in the colorimetry space as located on a trajectory between the first and second colorimetry values. The trajectory may be an axis or other path between the first and second colorimetry values for example. The trajectory may be defined by the separation, e.g. linear or angular, between the first and second colorimetry values, for example.

At block 540, first and second output color values are derived based on the target colorimetry value and the first and second sets of output color values, respectively. In examples, the deriving comprises, for each of the first and second sets of output color values, selecting a plurality of output color values in the respective set of output color values. The selecting may be based on the target colorimetry value. For example, the plurality of output color values in the first set of output color values may selected based on the target colorimetry value and the measured colorimetry values corresponding to each of the plurality of output color values in the first set of color values. Similarly, the plurality of output color values in the second set of output color values may selected based on the target colorimetry value and the measured colorimetry values corresponding to each of the plurality of output color values in the second set of color values. For example, a number of output color values having measured colorimetry values closest to, or within a predetermined threshold of, the target colorimetry value may be selected from the first and second sets of output color values to form the first and second pluralities of output color values, respectively.

Each selected plurality of output color values may be interpolated to derive the first and second output color values, respectively. For example, the selected pluralities of output color values may be triangulated to derive the first and second output color values, respectively.

At block 550, first and second mappings between the input color space and the output color space are generated by respectively assigning the first and second output color values to the input color value. Thus, the generated first mapping may map from the input color value, in the input color space, to the first output color value in the output color space. The generated second mapping may map from the input color value, in the input color space, to the second output color value in the output color space.

In examples, the method 500 includes receiving print control data for a printing operation, the print control data comprising the input color value in the input color space. For example, the printing operation may include an instruction to print the input color value representable in the input color space. The printing operation may use mappings to transform color values in the input color space to color values in the output color space, the color values in the output color space being printable by the printing system.

The method 500 may include determining the operating state of the printing system. For example, the direction of movement of the print material deposit mechanism, e.g. printhead, may be detected or predicted. In response to determining that the printing system is in the first operating state, the method 500 may include using the generated first mapping to perform the printing operation using the first output color value. For example, the input color value in the input color space may be mapped by the first mapping to the first output color value. The printing system may thus output, e.g. using the print material deposit mechanism moving in the first direction, the first output color value in place of the input color value in the print control data. In response to determining that the printing system is in the second operating state, the method 500 may instead include using the generated second mapping to perform the printing operation using the second output color value. The printing system may thus output, e.g. using the print material deposit mechanism moving in the second direction, the second output color value in place of the input color value in the print control data.

Certain methods and systems as described herein may be implemented by a processor that processes computer program code that is retrieved from a non-transitory storage medium.

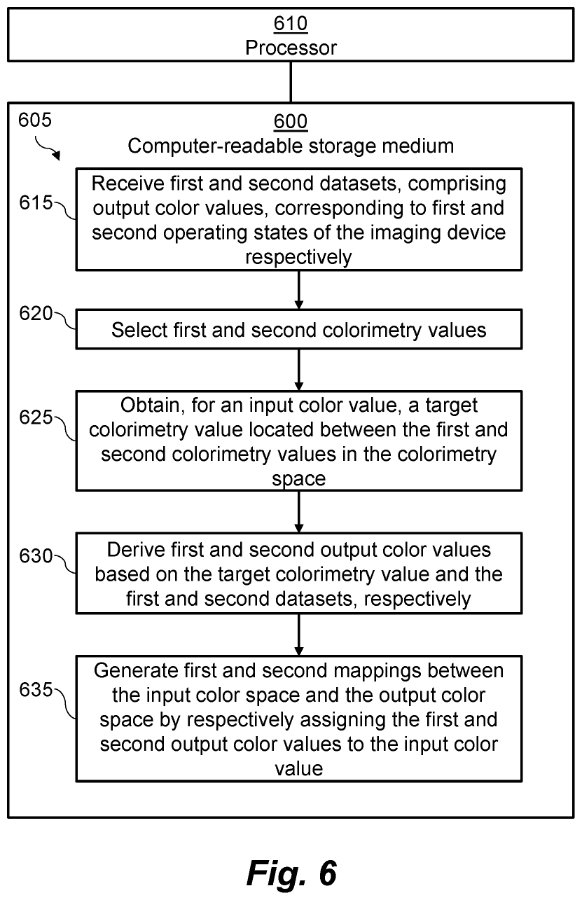

FIG. 6 shows an example non-transitory computer-readable storage medium 600 comprising a set of computer-readable instructions 605. The computer-readable storage medium 600 is communicatively coupled to a processor 610. The processor 610 and the computer-readable storage medium 600 may be components of an imaging system, for example the imaging system 100 described in examples above. The imaging system may comprise a printing system, as also described in examples above. The set of computer-readable instructions 605 may be executed by the processor 610.

In the example shown in FIG. 6, instruction 615 instructs the processor 610 to receive first and second datasets comprising output color values representable in an output color space. As described herein, a color value in a color space may comprise components corresponding to values, e.g. coordinates, in the color space, e.g. (r=236, g=122, b=63) in RGB space. The color value may therefore comprise a point in a respective color space. A color value in an NPac color space may comprise an NPac vector.

The first and second datasets correspond to first and second operating states of the imaging device, respectively. For example, the first and second datasets may comprise data representing output color values, in the output color space, which are producible by the imaging device when in the first and second operating states, respectively. The first and second operating states of the imaging system may correspond with first and second modes of the imaging system.

Each output color value in the first and second datasets corresponds to a measured colorimetry value representable in a colorimetry space. For example, a measured colorimetry value may be associated with each of the output color values in the first and second datasets. The measured colorimetry values may be stored as part of the respective dataset. The first and second datasets define respective first and second gamuts in the colorimetry space.

Instruction 620 instructs the processor 610 to select first and second colorimetry values in an intersection of the first and second gamuts. The selecting is based on the respective colorimetry of the first and second colorimetry values and a predetermined transition region in an input color space.

Instruction 625 instructs the processor 610 to obtain, for an input color value located in the predetermined transition region of the input color space, a corresponding target colorimetry value located between the first and second colorimetry values in the colorimetry space.

Instruction 630 instructs the processor 610 to derive first and second output color values based on the target colorimetry value and the first and second datasets, respectively.

Instruction 635 instructs the processor 610 to generate first and second mappings between the input color space and the output color space by respectively assigning the first and second output color values to the input color value.

Processor 610 can include a microprocessor, microcontroller, processor module or subsystem, programmable integrated circuit, programmable gate array, or another control or computing device. The computer-readable storage medium 600 can be implemented as one or multiple computer-readable storage media. Machine-readable media 600 can be any non-transitory media that can contain, store, or maintain programs and data for use by or in connection with an instruction execution system. For example, the computer-readable storage medium 600 may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. The computer-readable instructions 605 can be stored on one computer-readable storage medium, or alternatively, can be stored on multiple computer-readable storage media. The computer-readable storage medium 600 or media can be located either in an imaging system, such as a printing system, or located at a remote site from which computer-readable instructions can be downloaded over a network for execution by the processor 610.

According to some examples, the output color space may be defined as material volume coverage space for use in an additive manufacturing apparatus. In such examples, the vector components of a material volume coverage vector (MVoc) represent all materials available to the additive manufacturing apparatus and their combinations. In other words, the MVoc vectors are an enumeration of possible build or deposit states available to the additive manufacturing apparatus. The vector components of the MVoc may be considered analogous to the concept of Neugebauer Primaries as discussed above. In this analogy, each vector component may be considered to comprise a volume coverage of a “material primary”. As such the material volume coverage vector has a dimensionality representative of these states and contains the volume coverages (e.g. probabilities) associated with each state. Or in other words, the MVoc comprises weighted combinations or probabilities of material primaries. Thus, according to some examples, the techniques and methods described above with reference to the figures may be applied to generate first and second mappings to an MVoc space, e.g. from an input color space, in the additive manufacturing process.

Certain examples described herein enable an imaging system, having different operational states, to apply different color mappings during an imaging operation, depending on the operational state. The different color mappings map a given input color value in the input color space to different output color values in the output color space. When produced by the imaging system in its respective operational states, the different output color values may have a reduced perceivable difference in a color property, e.g. hue, compared to using color mappings generated by other methods. For example, the methods and systems described herein may allow for a more consistent color reproduction by printing systems utilizing multi-directional print-modes compared to other methods and systems.

The preceding description has been presented to illustrate and describe examples of the principles described. This description is not intended to be exhaustive or to limit these principles to any precise form disclosed. Many modifications and variations are possible in light of the above teaching. Although the flow diagram shows al specific order of execution, the order of execution may differ from that which is depicted.

What is claimed is:

1. A method comprising:
obtaining first and second sets of output color values representable in an output color space, the first and second sets of output color values corresponding to first and second operating states of a printing system respectively,
wherein each output color value in the first and second sets has corresponding coordinates in a colorimetry space, and wherein the first and second sets of output color values define respective first and second gamuts in the colorimetry space;
selecting first and second colorimetry values in an intersection of the first and second gamuts in the colorimetry space, the selecting based on the respective colorimetry of the first and second colorimetry values and a predetermined transition region in an input color space;
obtaining, for an input color value located in the predetermined transition region of the input color space, a corresponding target colorimetry value located between the first and second colorimetry values in the colorimetry space;
deriving first and second output color values based on the target colorimetry value and the first and second sets of output color values, respectively; and
generating first and second mappings between the input color space and the output color space by respectively assigning the first and second output color values to the input color value.

2. The method of claim 1, wherein the printing system comprises a moveable print material deposit mechanism to deposit print material, the first and second operating states of the printing system corresponding to first and second directions of movement of the print material deposit mechanism.

3. The method of claim 1, wherein the coordinates in the colorimetry space, corresponding to each output color value in the first and second sets of output color values, comprise measured colorimetry values.

4. The method of claim 3, comprising:
printing swatches using the printing system, the swatches corresponding to the output color values in the first and second sets;
measuring a colorimetry of each of the swatches; and
deriving the measured colorimetry values based on the measured colorimetries of the swatches.

5. The method of claim 1, wherein the deriving the first and second output color values based on the target colorimetry value and the first and second sets of output color values, respectively, comprises, for each of the first and second sets:
selecting a plurality of output color values in the respective set of output color values, the selecting based on the target colorimetry value; and
interpolating the selected plurality of output color values.

6. The method of claim 1, wherein the first and second sets of output color values respectively comprise first and second sets of Neugebauer Primary Area Coverage (NPac) vectors, each NPac vector defining a statistical distribution of Neugebauer Primaries (NPs) over an area of a halftone.

7. The method of claim 6, comprising determining the first and second sets of output color values representable in the output color space, and corresponding to the first and second operating states of a printing system respectively,
wherein the determining is based on an overprinting criterion.

8. The method of claim 1, comprising:
receiving print control data for a printing operation, the print control data comprising the input color value in the input color space;
determining the operating state of the printing system; and
in response to determining that the printing system is in the first operating state, using the generated first mapping to perform the printing operation using the first output color value; or
in response to determining that the printing system is in the second operating state, using the generated second mapping to perform the printing operation using the second output color value.

9. The method of claim 1, wherein the respective first and second gamuts in the colorimetry space, corresponding to the first and second sets of output color values, are represented in a chromaticity plane of the colorimetry space, and
wherein the selecting the first and second colorimetry values based on their respective colorimetry comprises selecting the first and second colorimetry values based on a linear or angular separation therebetween in the chromaticity plane of the colorimetry space.

10. An imaging system comprising:
an imaging device to produce an image output;
a memory to store:
data representing first and second sets of output color values, each output color value being representable in an output color space, the first and second sets of output color values corresponding to first and second operating states of the imaging device respectively,
wherein each output color value in the first and second sets has a corresponding measured colorimetry value representable in a colorimetry space, and wherein the first and second sets of output color values define respective first and second gamuts in the colorimetry space; and
an imaging controller to:
select first and second colorimetry values in an intersection of the first and second gamuts in the colorimetry space, the selecting based on the respective colorimetry of the first and second colorimetry values and a predetermined transition region in an input color space;
obtain, for an input color value located in the predetermined transition region of the input color space, a corresponding target colorimetry value located between the first and second colorimetry values in the colorimetry space;
derive first and second output color values based on the target colorimetry value and the first and second sets of output color values, respectively; and
generate first and second output data respectively associating the first and second output color values in the output color space with the input color value in the input color space.

11. The imaging system of claim 10, comprising a printing system,
wherein the imaging device comprises a printing device to apply print material onto a print target, and
wherein the imaging controller comprises a print controller.

12. The imaging system of claim 11, the printing device being moveable in a first direction and a second direction to apply the print material onto the print target,
wherein the first and second operating states of the imaging device comprise the printing device moving in the first and second directions, respectively.

13. The imaging system of claim 10, wherein the imaging controller is to store the generated first and second output data, respectively associating the first and second output color values with the input color value, in respective first and second color lookup tables.

14. The imaging system of claim 13, wherein the imaging controller is to:
receive image control data for an imaging operation, for producing the image output at the imaging device, the image control data comprising the input color value in the input color space;
determine the operating state of the imaging system; and
in response to determining that the imaging system is in the first operating state, use the first color lookup table to perform the imaging operation; or
in response to determining that the imaging system is in the second operating state, use the second color lookup table to perform the imaging operation.

15. A non-transitory computer-readable storage medium comprising a set of computer-readable instructions that, when executed by a processor of an imaging system, cause the processor to:
receive first and second datasets comprising output color values representable in an output color space, the first and second datasets corresponding to first and second operating states of the imaging device respectively,
each output color value in the first and second datasets having a corresponding measured colorimetry value representable in a colorimetry space, wherein the first and second datasets define respective first and second gamuts in the colorimetry space;
select first and second colorimetry values in an intersection of the first and second gamuts, the selecting based on the respective colorimetry of the first and second colorimetry values and a predetermined transition region in an input color space;
obtain, for an input color value located in the predetermined transition region of the input color space, a corresponding target colorimetry value located between the first and second colorimetry values in the colorimetry space;
derive first and second output color values based on the target colorimetry value and the first and second datasets, respectively; and
generate first and second mappings between the input color space and the output color space by respectively assigning the first and second output color values to the input color value.
